(19) United States
(12) Patent Application Publication
(10) Pub. No.: US 2013/0008534 A1
(43) Pub. Date: Jan. 10, 2013

(54) STEAM INJECTION MECHANISM, PRODUCT PROCESSING APPARATUS HAVING THE STEAM INJECTION MECHANISM, AND METHOD OF MAKING THE STEAM INJECTION MECHANISM

(75) Inventors: Taishi Nakamura, Kanonji-shi (JP); Shinichi Ishikawa, Kanonji-shi (JP); Jun Okuda, Kanonji-shi (JP)

(73) Assignee: UNICHARM CORPORATION, Ehime (JP)

(21) Appl. No.: 13/636,224

(22) PCT Filed: Mar. 30, 2011
(86) PCT No.: PCT/JP2011/001939

§ 371 Date: Sep. 20, 2012

(30) Foreign Application Priority Data
Mar. 30, 2010 (JP) 2010-079670

(51) Int. Cl. F17D 1/00; B21D 51/16

(52) U.S. Cl. 137/561 A; 29/890.09

(57) ABSTRACT

The present invention provides a steam injection mechanism improved so that water accumulation on an object to be processed can be reliably restricted. A steam injection mechanism comprises a common channel through which steam supplied from a steam supply source flows and distribution channels branched from the common channel to distribute the steam from the common channel wherein the steam is injected from steam injection orifices formed in distal ends of the distribution channels to an object (a fibrous nonwoven fabric) to be processed. When the steam injection mechanism is located above the fibrous nonwoven fabric, the lowermost region of the common channel functions as a condensed water collecting region and, when the steam injection mechanism is located under the fibrous nonwoven fabric, the uppermost region of the common channel functions as the condensed water collecting region.

### TECHNICAL FIELD

The present disclosure relates to product processing apparatus having steam injection mechanisms therefor and more particularly, to such steam injection mechanisms used for production of nonwoven fabrics from fibers, and methods of making parts of the steam injection mechanism.

### RELATED ART

Steam injection mechanisms are known to comprise a common channel supplied with steam directly from a steam supply source and distribution channels into which steam from the common channel is distributed, wherein steam is injected from steam injection orifices formed at ends of the respective distribution channels to a fiber web. For example, JP 2004-238785 A (PATENT DOCUMENT 1) discloses a steam injection system with the following features:

(1) A nozzle holder having therein a cylindrical common channel is arranged to extend in a horizontal direction. This common channel is formed along a lower portion with a slit-like opening extending in the horizontal direction.

(2) A rectangular solid-shaped bar is formed with a plurality of distribution channels each extending in a vertical direction and having a circular cross-section taken in a plane being orthogonal to the vertical direction. The rectangular solid-shaped bar is connected to the nozzle holder so that upper ends of the respective distribution channels may communicate with the common channel via the slit-like opening.

(3) Lower ends of the respective distribution channels are formed with steam injection orifices.

(4) The steam injection mechanism is located above the fiber web and steam is injected downward from the steam injection orifices to the fiber web so that thermoplastic fibers of the fiber web may be fusion-bonded together to make entangled fibrous nonwoven fabrics.

PATENT DOCUMENT 1 discloses that the steam injection mechanism can also be located below the fiber web and a suction box to suck steam is located above the fiber web so that steam is injected upward to the fiber web.

Citation List

Patent Literature

[PATENT DOCUMENT 1] JP 2004-238785 A

### SUMMARY OF INVENTION

Problem to be Solved by the Invention

However, the inventors have noted the following. Superheated steam or saturated steam is condensed to water just as such steam loses its energy. In a technique using such steam to treat an object to be treated, if the steam injection mechanism is located above the fiber web, water having been partially condensed from steam in the common channel flows into the distribution channels under the effect of gravity and is injected together with steam. The water injected together with steam from the steam injection orifices accumulates on the fiber web. Such accumulating water prevents steam from passing through the fiber web. While component fibers in regions of the web through which steam passes are entangled together, component fibers in regions through which steam is prevented from passing are not properly entangled together. Inevitably, it is difficult to achieve uniform interlacing effect and such unevenly entangled fibers might lead to deterioration of the product.

Measure to Solve the Problem

According to one or more embodiments of the present invention on the first aspect, a steam injection mechanism comprises a common channel through which steam supplied from a steam supply source is arranged to flow, distribution channels branched from the common channel to distribute the steam from the common channel, and steam injection orifices formed at distal ends of the distribution channels to inject the streams of steam onto an object to be processed.

The common channel is provided with a region adapted to collect water condensed from steam regardless of whether the steam injection orifices are oriented upward or downward.

According to one or more embodiments the present invention on the second aspect, a product processing apparatus comprises a conveyor for transporting an object to be processed in a machine direction, and a steam injection mechanism extending across the conveyor in a cross direction transverse to the machine direction. The steam injection mechanism comprises a common channel through which steam supplied from a steam supply source is arranged to flow, at least one distribution channel branched from the common channel to distribute the steam from the common channel, and

steam injection orifices formed at a distal end of the distribution channel and oriented toward the conveyor to inject the steam on to the object to be processed. The common channel is provided with a condensed water collecting region adapted to collect water condensed from steam regardless of whether the steam injection mechanism is positioned below or above the conveyor.

According to one or more embodiments the present invention on the third aspect, a method of making parts of a steam injection mechanism comprises:

(a) boring a rectangular block -shaped first block in a cross direction from a first side wall to a second side wall of the first block as viewed in the cross direction to form the common channel;

(b) boring the first block in a front-back direction from any one of side walls of the first block in the front-back direction up to the common channel to form passageways;

(c) plugging the passageways at the one side wall to form first segments of the distribution channels; and

(d) boring the first block upward in the vertical direction from a bottom wall of the first block up to the first segments to form second segments of the distribution channels.

### BRIEF DESCRIPTION OF DRAWINGS

FIG. 1 is a perspective view partially illustrating a processing apparatus including a steam injection mechanism in accordance with some embodiments.

FIG. 2 is a schematic side view illustrating the processing apparatus generally as a whole.

FIG. 3 is a perspective view of a first block of the steam injection mechanism.

FIG. 4 is a cross-sectional view of the steam injection mechanism according to some embodiments of the present invention.

FIG. 5 is a perspective view of a second block of the steam injection mechanism.

FIG. 6 is a perspective view of an exemplary composite laminate to be processed by the steam injection mechanism.

FIG. 7 is a cross-sectional view illustrating the steam injection mechanism according to one exemplary embodiment of the present invention.

FIG. 8 is a cross-sectional view illustrating the steam injection mechanism according to another exemplary embodiment of the present invention.

FIG. 9 is a cross-sectional view illustrating the steam injection mechanism according to still another exemplary embodiment of the present invention.

FIG. 10 is a cross-sectional view illustrating the steam injection mechanism according to yet another exemplary embodiment of the present invention.

FIG. 11 is a cross-sectional view illustrating the steam injection mechanism according to further another exemplary embodiment of the present invention.

### DETAILED DESCRIPTION OF THE PREFERRED EMBODIMENTS

Details of a steam injection mechanism and a method of making the same according to some embodiments of the present invention will be more fully understood from the description given hereunder with reference to the accompanying drawings. In the accompanying drawings, MD indicates a machine direction, CD indicates a cross direction extending across (e.g., orthogonally to) the machine direction MD, and V indicates a perpendicular (i.e., vertical) direction. It should be understood that the machine direction MD and the direction opposite thereto may be designated generally as a front-back direction.

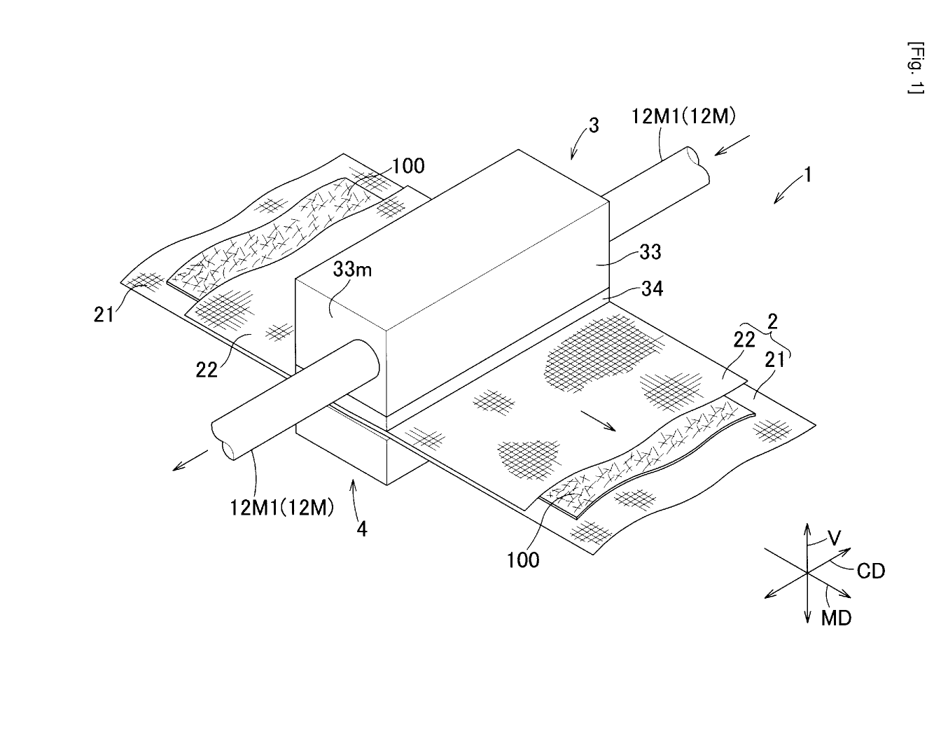

Referring to FIG. 1, a processing apparatus 1 comprises a conveyor 2 serving to convey an object 100 to be processed, for example, a fibrous nonwoven fabric, a steam injection mechanism 3 serving to inject steam, and a steam suction mechanism 4 serving to suck steam injected from the steam injection mechanism 3.

The conveyor 2 comprises a first or lower holding member 21 and a second, or upper holding member 22 cooperating with each other to sandwich the object 100 in between.

The first holding member 21 is an endless belt, for example, formed of metallic wires knitted in a mesh texture to assure a desired open area ratio. This first holding member 21 is put, for example, on the outside of a plurality of rotating rolls (not shown) and runs in the machine direction MD in FIG. 1. The object 100 to be processed, for example, a fiber web of which the component fibers are still neither entangled nor joined together or having already been entangled or joined together are placed on this first holding member 21. As an example, a fibrous nonwoven fabric made of thermoplastic synthetic resin fibers is placed on this first holding member 21.

The second holding member 22 is an endless belt, for example, formed of metallic wires knitted in a mesh texture to assure a desired open area ratio. This second holding member 22 is put, for example, on the outside of a plurality of rotating rolls (not shown) and cooperates with the first holding member 21 to sandwich therebetween the object 100 to be processed. With such arrangement, the object 100 to be processed and the second holding member 22 also run in the machine direction MD in FIG. 1 as the first holding member 21.

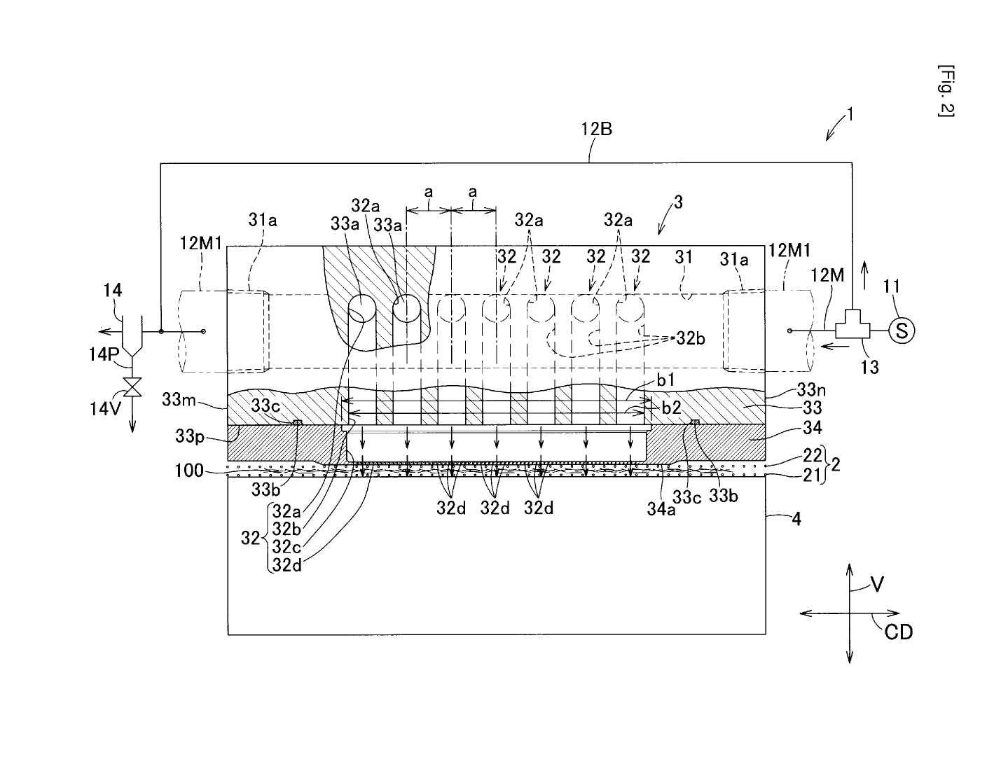

Referring to FIG. 2, the processing apparatus 1 comprises a stream supply source 11 for superheated steam, a main pathway 12M passing through the steam injection mechanism 3 to make efficient use of steam supplied from the steam supply source 11, a bypass valve 13 provided in mid-course of the main pathway 12M on the upstream side of the steam injection mechanism 3, a bypass pathway 12B to allow the supplied steam to bypass the steam injection mechanism 3 in a manner in which the bypass pathway 12B joins again to the main pathway 12M after this main pathway 12M having passed through the steam injection mechanism 3, and a drain tank 14 to collect water condensed due to loss of steam energy.

The drain tank 14 is located in a region on a downstream side of the steam injection mechanism 3, more specifically, in a region downstream of a point at which the bypass pathway 12B is joined to the main pathway 12M. The drain tank 14 is provided on its bottom with a drain pipe 14P serving to drain away the condensed water collected within the drain tank 14. Along this drain pipe 14P, a drain valve 14V is located. The drain valve 14V is normally kept closed to prevent the condensed water collected within the drain tank 14 from draining from the drain tank 14 via the drain pipe 14P. However, the drain valve 14V is configured to be automatically opened when a predetermined amount of condense water has been collected within the drain tank 14 and thereby to allow the amount of condensed water to drain from the drain tank 14.

The steam injection mechanism 3 is provided with a common channel 31 as a part of the main pathway 12M and at least one distribution channel, e.g., a plurality of distribution channels 32, branched from the common channel 31. As viewed in FIG. 2, i.e., along a plane extending in the cross direction CD which extends across the direction in which the common channel 31 extends, the steam injection mechanism 3 includes seven distribution channels 32 arranged in the cross direction CD at a center-to-center spacing a. Each of the distribution channels 32 comprises a first segment 32a, a second segment 32b, a third segment 32c and a steam injection orifice 32d.

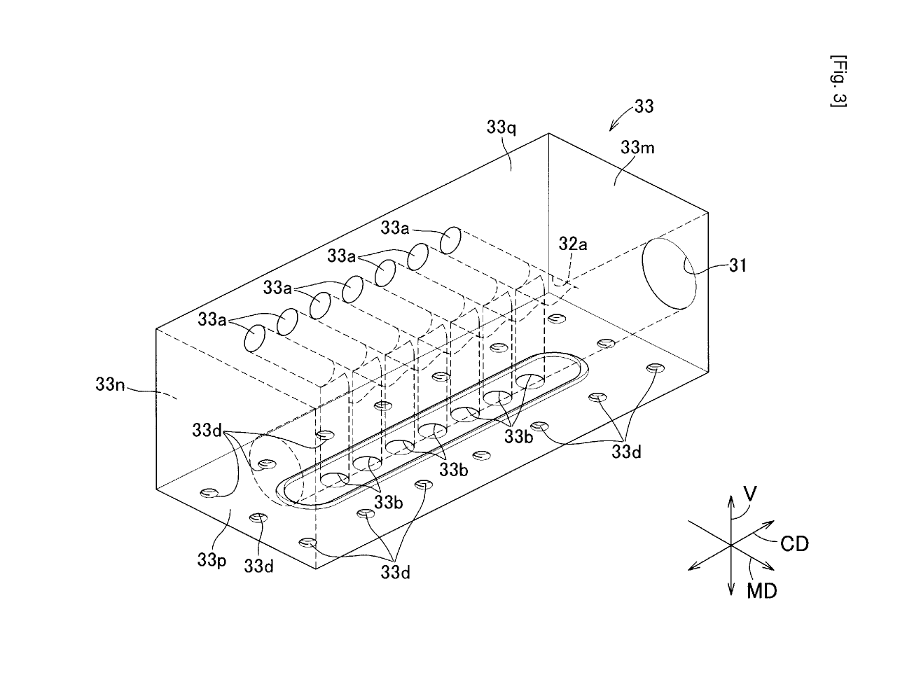

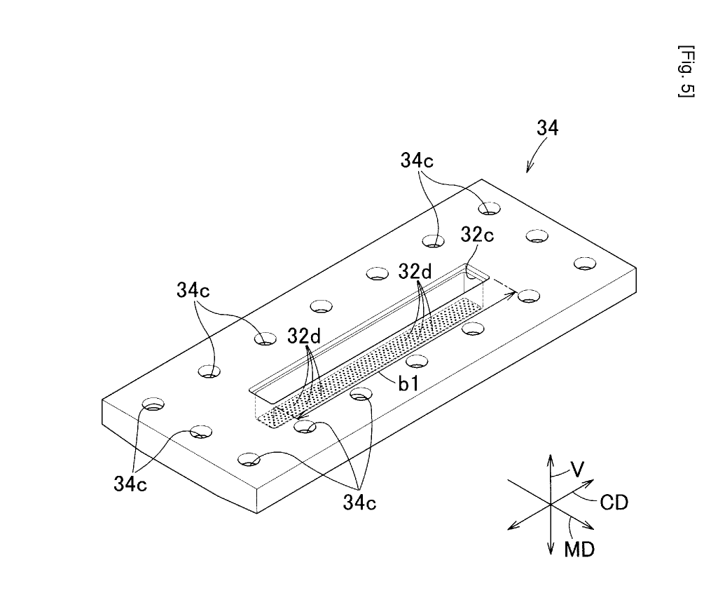

The steam injection mechanism 3 further includes an upper block 33 and a second lower block 34 each formed of, for example, metallic materials such as stainless alloys. As will be apparent from FIGS. 3 and 5, the first block 33 and the second block 34 have the vertical direction V, the cross direction CD and the front-back direction to have a shape of a rectangular block.

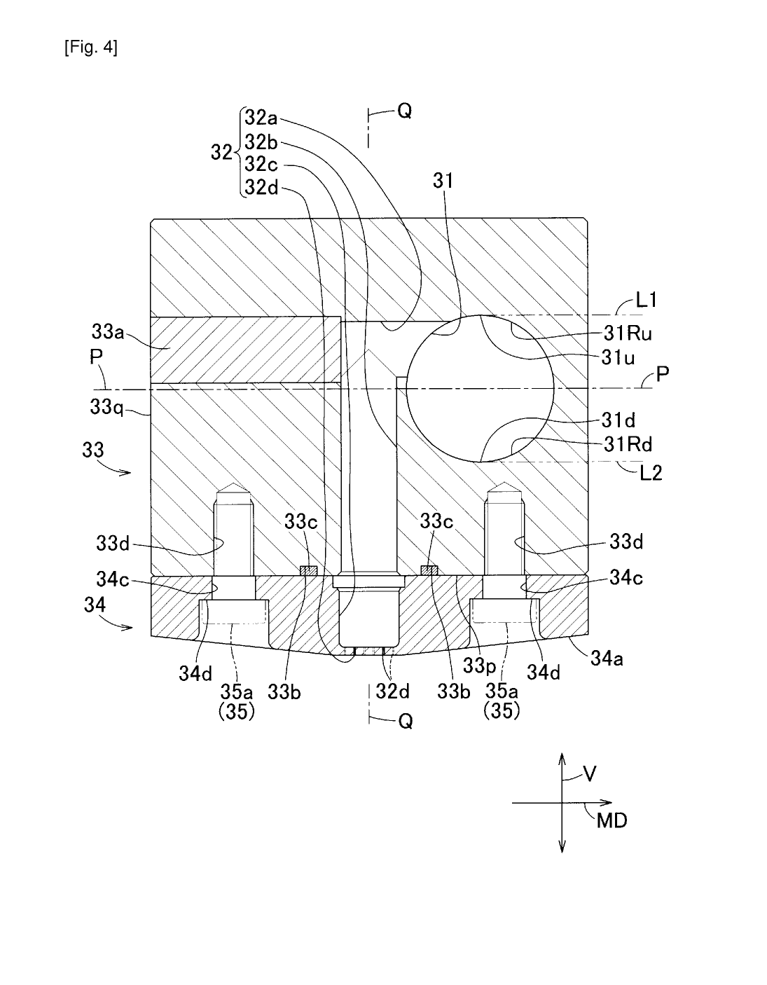

Referring to FIG. 3, the first block 33 is formed with the common channel 31 extending generally in a horizontal direction corresponding to the cross direction CD. As will be explained more specifically herein below, in some embodiments, the common channel 31 is slightly inclined relative to the horizontal plane to facilitate drainage of condensed water toward an end of the common channel 31. As illustrated in FIGS. 3 and 4, the common channel 31 is a passageway (or conduit) having a circular shape in its cross-section taken perpendicular to an axis of the common channel 31 which extends generally in the cross direction CD but at an inclination relative to the horizontal plane. This passageway of the common channel 31 extends through the first block 33 from a first side wall 33m (right side wall in FIG. 3) to a second side wall 33n (left side wall in FIG. 3) in the cross direction CD. Steam supplied from the steam supply source 11 flows through this common channel 31.

The first block 33 is formed with a plurality of the first segments 32a of the respective distribution channels 32. Each of the first segments 32a is a passageway having a circular shape in its cross-section taken orthogonally to the front-back direction and defines the uppermost segment just branched from the common channel 31.

Referring to FIG. 4, the first segments 32a of the respective distribution channels 32 communicate with the common channel 31 at a level defined between a horizontal tangent line L1 to the uppermost region 31u and a horizontal tangent line L2 to the lowermost region 31d of the common channel 31 as viewed in the cross-section. Below regions in which the common channel 31 communicates with the first segments 32a of the respective distribution channels 32, the common channel 31 includes a lower peripheral region 31Rd not directly communicating with the first segments 32a. Also above the regions in which the common channel 31 communicates with the first segments 32a of the respective distribution channels 32, the common channel 31 includes an upper peripheral region 31Ru not directly communicating with the first segments 32a. More specifically, the respective first segments 32a communicate with the common channel 31 above a central line P-P bisecting the common channel 31 in said cross-section. In other words, the respective first segments 32a communicate with the common channel 31 above the lower half of the common channel 31 in said cross-section.

The first block 33 is formed with the second segments 32b of the respective distribution channels 31. Each of the second segments 32b is a passageway having a circular shape in its sectional view taken orthogonally to the vertical direction V and extending in the vertical direction V from the associated first segment 32a to a bottom wall 33p of the first block 33. As will be apparent from FIG. 4, the first segment 32a communicates with the second segment 32b to define an L-shape.

Such first block 33 may be made by a method comprising, for example, the following in accordance with some embodiments:

(a) First, the first block 33 may be formed, e.g., bored, in a first direction (generally corresponding to the cross direction CD when the mechanism is used) from a first side wall (right side wall as viewed in FIG. 3) 33m to a second side wall (left side wall as viewed in FIG. 3) 33n to form the common channel 31.

(b) The first block 33 may be formed, e.g., bored, in a second direction (generally corresponding to the machine direction MD or the front-back direction when the mechanism is used) from a third side wall 33q on the upstream side (i.e., a rear side as viewed in the front-back direction) toward the downstream side (i.e., a front side as viewed in the front-back direction), specifically, up to the common channel 31 to form the first segment passageway. Such boring operation may be repeated to obtain a total of seven first segments each extending in the front-back direction.

(c) Upstream side ends of the respective openings extending in the front-back direction in a third side wall 33q may be plugged by plugging members 33a to form the first segments 32a.

(d) Finally, the first block 33 may be formed, e.g., bored, in a third direction (generally corresponding to the upward vertical direction V when the mechanism is used) from bottom wall 33p up to the first segment 32a to form the second segment 32b. Such boring operation may be repeated to obtain a total of seven second segments 32b. In some embodiments, the first, second and third directions are mutually perpendicular. In further embodiments, an angle between any two of the first through third directions, e.g., the angle between the first and third directions, is other than 90 degrees, e.g., slightly off 90 degrees. In one or more embodiments, the first block 33 is molded with one or more of the common channel 31, the first segments 32a and the second segments 32b therein, thereby reducing the amount of boring operations. The common channel 31, the first segments 32a and the second segments 32b can be rectilinearly formed as has been described above and thereby these channel 31, first segments 32a and the second segments 32b can be easily formed.

Referring to FIG. 2, opposite ends of the common channel 31 as viewed in the front-back direction are formed on inner peripheral surfaces with female threads 31a, respectively. The respective threads 31a are to be engaged with male threads (not shown) formed on an outer peripheral surface of one end of each pipe 12M1 indicated by imaginary lines in FIG. 2. The pipes 12M1 form a part of the main pathway 12M. The male threads of the respective pipes 12M1 may be engaged with the female threads 31a of the common channel 31 so that the inner peripheral surface of the pipe 12M1 may be aligned with the inner peripheral surface to assure that loss of the stream of steam which might otherwise occur in the joint regions is prevented.

Referring to FIGS. 2, 3 and 4, the bottom wall 33p of the first block 33 is formed with a groove 33b depressed upward from bottom surface and extending to surrounding the lower ends of all the seven second segments 32b. An O-ring 33c is set in this groove 33b to prevent steam leak from between the first block 33 and the second block 34.

As will be seen in FIGS. 3 and 4, the bottom wall 33p of the first block 33 has threaded holes 33d extending upward from the bottom surface. These threaded holes 33d are arranged along a peripheral edge of the bottom wall 33p of the first block 33 at a predetermined pitch. On the bottom wall 33p of the first block 33, these threaded holes 33d are arranged further outside the groove 33b surrounding all the second segments 32b. Each of these threaded holes is formed in its inner peripheral surface with a female thread (not shown).

Referring to FIGS. 1, 2 and 4, the second block 34 has same dimensions as those of the first block 33 in the front-back direction as well as in the cross direction CD.

Referring to FIG. 4, the second block 34 is symmetric about the center line Q-Q bisecting a dimension of the second block 34 in the front-back direction. While an upper surface of the second block 34 is flat, a bottom surface thereof is formed with a protruding area 34a. Specifically, this protruding area 34a protrudes downward gradually from both lateral sides opposed in the front-back direction toward the center line Q-Q to define, as will be seen in FIG. 2, a central region protruding downward in the cross direction CD relative to the right and left lateral sides.

Referring to FIG. 5, the second block 34 is formed, for each second segment 32b, with a third segment 32c and steam injection orifices 32d.

The third segment 32c of the distribution channel 32 is defined by a pit-like depression extending downward from an upper surface of the second block 34. Referring to FIG. 2, a dimension b 1 of the third segment 32c in the vicinity of the upper surface of the second block 34 as measured in the cross direction CD is larger than a dimension b2 as measured from the outer end of the second segment 32b formed on the rightmost side in the cross direction CD to the outer end of the second segment 32b formed on the leftmost side in the cross direction CD but, in the front-back direction, a dimension of the third segment 32c of the second block 34 as measured on the upper surface thereof is substantially the same as the corresponding dimension of the second segments 32b so that the respective second segments 32b are properly in communication with the third segment 32c in the vertical direction as will be apparent from FIG. 4. In other words, assumed that the position of the steam supply source 11 is designated as the upstream and the position of the drain tank 14 is designated as the downstream on the basis of the direction in which steam flows, the second segments 32b on the upstream side are rectilinearly connected to the third segment 32c on the downstream side.

The steam injection orifices 32d serve to inject steam and are formed through the bottom wall of the third segment 32c in the form of the pit-like depression. The third segment 32c communicates with a space defined under the protruding area 34a of the second block 34 via these steam injection orifices 32d and each of these steam injection orifices 32d is an opening having a circular shape in a section taken orthogonally to the vertical direction and extending in the vertical direction V. These steam injection orifices 32d are arranged in a row in the cross direction CD and a plurality of such rows are arranged in the front-back direction. In this way, the bottom wall of the third segment 32c is uniformly provided over substantially its entire area with such steam injection orifices 32d. In other words, all the distribution channels 32 are provided at the distal ends thereof with such steam injection orifices 32d and therefore the third segment 32c rectilinearly communicates with the steam injection orifices 32d in the direction of steam flow.

The second block 34 is formed, as will be seen in FIGS. 4 and 5, with a plurality of through-holes 34c extending through the second block 34 in vertical direction V. These through-holes 34c are arranged along peripheral edges of the upper surface and the bottom surface of the second block 34 at a predetermined pitch so as to be aligned with the threaded holes 33d of the first block 33. The lower surface of the second block 34 is formed with depressions 34d in center-aligned relationship with the respective through-holes 34c.

To attach the second block 34 to the first block 33, the through-holes 34c may be aligned with the associated threaded holes 33d, distal ends of bolts 35 (indicated by imaginary lines in FIG. 4), each formed with a male thread to be engaged with the female thread of the associated threaded hole 33d, may be inserted into the associated through-holes 34c and threaded holes 33d, and the male threads of the respective bolts may be engaged with the female threads of threaded holes 33d. Thereupon, heads 35a of the respective bolts 35 fit together with the associated depressions 34d by insertion. In this way, the depressions 34d serve to prevent the heads 35a of the respective bolts 35 from sticking out. Specifically, in the course of processing the object 100 as the second holding member 22 is put in contact with the lower surface of the second block 34, the depressions 34d serve to prevent the bolt heads 35a from being caught by the second holding member 22.

The steam injection mechanism 3 comprising the first block 33 and the second block 34 constructed as has been described above and the steam suction mechanism 4 are located so that the holding member 2 may be sandwiched between these two mechanisms 3, 4 as illustrated in FIG. 1. Specifically, the steam suction mechanism 4 is kept in contact with the lower surface of the first holding member 21 so that the steam suction mechanism 4 may support the first holding member 21 and the steam injection mechanism 3 is located directly above the second holding member 22 so that the protruding area 34a may be kept in contact with the upper surface of the second holding member 22. More specifically, the steam injection mechanism 3 is located above the second holding member 22 so that the machine direction (i.e., front-back direction) MD may orthogonally cross the cross direction (i.e., transverse direction) CD. When the steam injection mechanism 3 is located above the conveyor 2, the common channel 31 is slightly slanted downward relative to the horizontal plane from the right side wall (the second side wall 33n) as viewed in FIG. 2 directly communicating with the steam supply source 11 to the left side wall (the side wall (the first side wall 33m) as viewed in FIG. 2 directly communicating with the drain tank 14. By slanting the steam injection mechanism 3 in this manner, the direction in which steam flows can be matched to the direction in which the condensed water is drained off. In some embodiments, the slanted direction of the common channel 31 is achieved by forming, e.g., boring, the common channel 31 at a slanted (first) direction relative to the bottom wall 33p of the first block 33 which is arranged horizontally when the mechanism is in operation.

In further embodiments, the slanted direction of the common channel 31 is achieved by forming, e.g., boring, the common channel 31 parallel to the bottom wall 33p of the first block 33 and then arranging both the common channel 31 and the bottom wall 33p of the first block 33 at a small angle relative to the horizontal plane. The conveyor 2 may be inclined as well to be parallel to the bottom wall 33p of the first block 33. Other arrangements are contemplated in other embodiments, provided that the common channel 31 is slanted relative to the horizontal plane.

Now, the operation of the processing apparatus 1 and the steam injection mechanism 3 will be described. First, the bypass valve 13 is changed over so that steam supplied from the steam supply source 11 may flow through the steam injection mechanism 3.

After the steam injection mechanism 3 has been heated by steam at a predetermined temperature or higher, the first holding member 21 cooperating with the second holding member 22 to sandwich the object 100 to be processed may be driven to run in the machine direction MD.

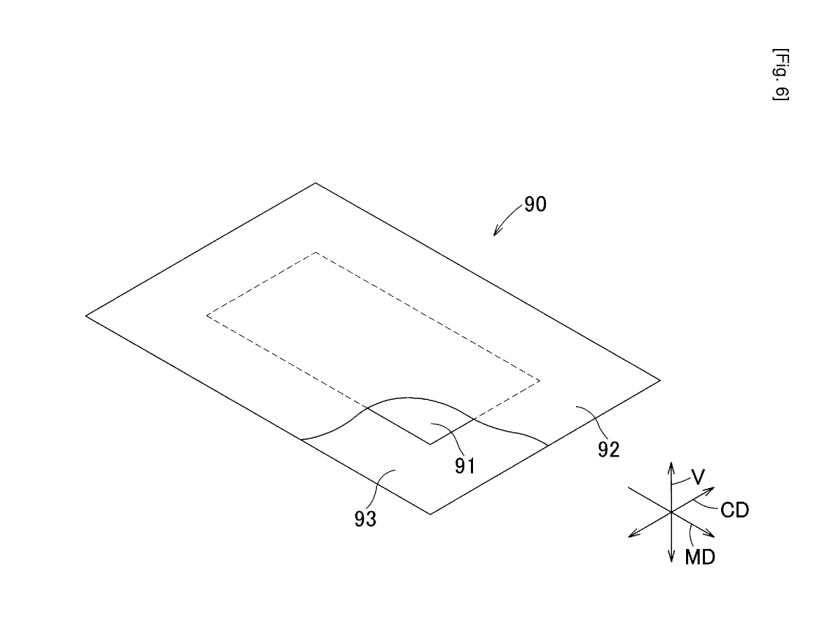

In the steam injection mechanism 3, streams of steam coming from the steam supply source 11 is injected via the distribution channels 32 and the steam injection orifices 32d. Streams of steam injected from the steam injection mechanism 3 pass through the second holding member 22, then through the object 100 to be processed and the first holding member 21 and thereafter steam is sucked by the steam suction mechanism 4. If the object 100 to be processed is a fibrous web, component fibers of thermoplastic synthetic resin are fusion bonded together as steam passes through the web, In consequence, an entangled fibrous nonwoven fabric is formed. The entangled fibrous nonwoven fabric may be cut into an appropriate shape to obtain, for example, a liquid-pervious topsheet which can be used for a bodily fluid-absorbent article such as a disposable diaper or a menstruation napkin. Furthermore, a topsheet, a liquid-absorbent core material and a backsheet laminated one on another may be sandwiched between the first holding member 21 and the second holding member 22 and may be processed with steam. For example, as illustrated in FIG. 6, a composite laminate 90 comprising the topsheet 92, the liquid-absorbent core material 91 and the backsheet 93 is processed with steam jets and appropriately thinned in the vertical direction V.

Water condensed from steam flowing from the common channel 31 to the distribution channels 32 accumulates in the lowermost region 31d of the lower peripheral surface 31Rd of the common channel 31 which is not directly communicated with the respective first segments 32a as will be apparent from FIG. 4. In this way, the lowermost region 31d of the common channel 31 functions as the collecting region for water condensed from steam.

Water collected in the lowermost region 31d of the common channel 31 flows to the left side wall (i.e., the first side wall 33m) as shown in FIG. 2 and is collected through a part of the main pathway 12M into the drain tank 14 since the steam injection mechanism 3 is slanted as seen in FIG. 2. If the steam injection mechanism 3 is located under the conveyor 2, i.e., the positional relationship is turned upside down, the uppermost region 31u of the upper peripheral surface 31Ru of the common channel 31 which is not directly communicated with the first segments 32a of the respective distribution channels 32 functions as the condensed water collecting region. In other words, the lowest region of the common channel 31, as seen in the vertical direction V, is not directly communicated with the distribution channels 32 and functions as the condensed water collecting region.

With the steam injection mechanism 3 constructed in this manner, the common channel 31 is provided with the condensed water collecting region regardless of whether the steam injection mechanism 3 is located above the conveyor 2 or under the conveyor 2 (i.e., regardless of whether the steam injection orifices are oriented upward or downward) and, therefore, water condensed from steam can be collected within the common channel 31. In consequence, accumulation of the condensed water on the object to be processed can be restricted regardless of whether the steam injection mechanism 3 is located above or under the object to be processed.

The distribution channels 32 directly communicate with the common channel 31 above the lower half of the common channel 31 as viewed in the cross-section. With this arrangement, water condensed from steam would not flow into the distribution channels 32.

Referring to FIG. 4, while the first segment 32a communicates with the second segment 32b in an L-shape, the first segment 32a, the second segment 32b and the third segment 32c are respectively formed to be rectilinear and the third segment 32c rectilinearly communicates with the steam injection orifices 32d. In other words, each of the distribution channels 32 has a maximum of only one turning point and this feature advantageously restrict loss of steam energy.

The construction illustrated in FIGS. 1 through 5 is in accordance with one or more embodiments of the present invention and the present invention is not limited to such embodiment(s). For example, the number of the distribution channels 32 is not limited to seven but may be appropriately increased or decreased.

It is possible to provide the common channel 31 with a heater (not shown) and thereby to prevent steam from being condensed.

In the process of making the first block 33, it is also possible that, after the first block 33 has been bored upward in the vertical direction V from bottom wall 33p to the first segment 32a to form the second segment 32b ((d)), the openings formed through the third side wall 33q, i.e., rear side wall as viewed in the front-back direction are plugged by the plugging members 33a ((c)).

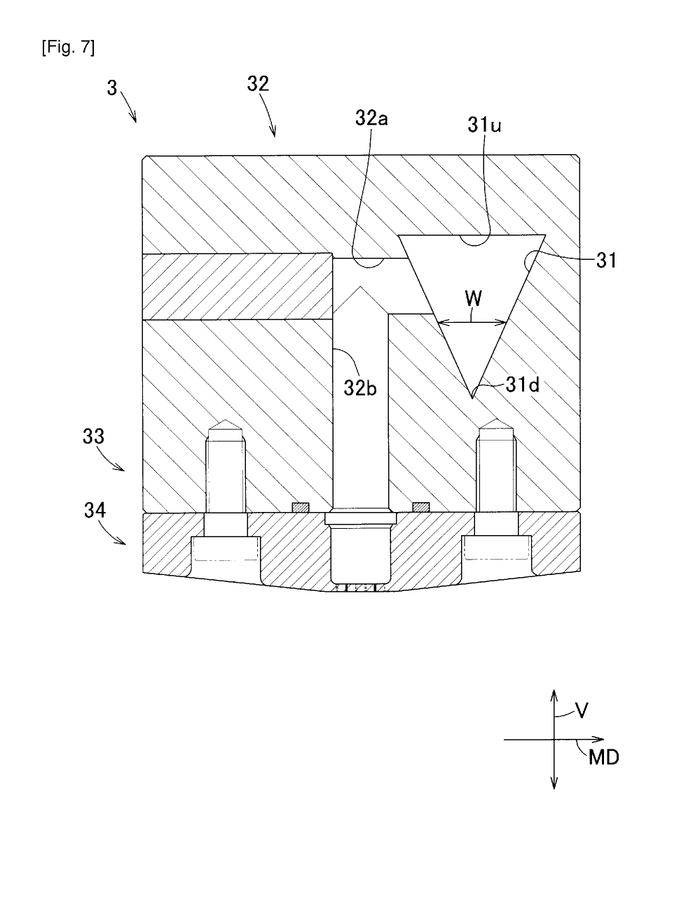

The cross sectional shape of the common channel 31 may be appropriately varied as exemplarily illustrated in FIGS. 7 through 11.

In the embodiment illustrated in FIG. 7, the common channel 31 has a triangular shape as viewed in the cross-section. More specifically, the common channel 31 has the triangular opening, as viewed in the cross-section, having a dimension W in the front-back direction gradually reducing downward toward the steam injection orifices 32d (or enlarging gradually upward away from the steam injection orifices 32d).

By shaping the common channel 31 so that the dimension W thereof in the front-back direction being orthogonal to the cross direction in which the common channel 31 extends and to the vertical direction V may be gradually reduced downward, an amount of water condensed from steam can be collected in the lowermost region 31d of the common channel 31 is not directly communicated with the respective distribution channels 32. In other words, in the case of this steam injection mechanism 3, the lowermost region 31d of the common channel 31 functions as the condensed water collecting region.

If the steam injection mechanism 3 is located under the holding member 2, i.e., the positional relationship is turned upside down, any amount of water condensed from steam is collected in the uppermost region 31u which is not directly communicated with the respective distribution channels 32 and the uppermost region 31u functions as the condensed water collecting region.

Though not illustrated, the common channel 31 may be formed so as to have quadrangular or oval shape in the cross-section. In further embodiments, the common channel 31 may have the cross-sectional shape other than the quadrangular or oval shape.

It is also possible to form the common channel 31 so that the cross-sectional shape may be defined by a combination of above-mentioned quadrangular shape, triangular shape and oval shape.

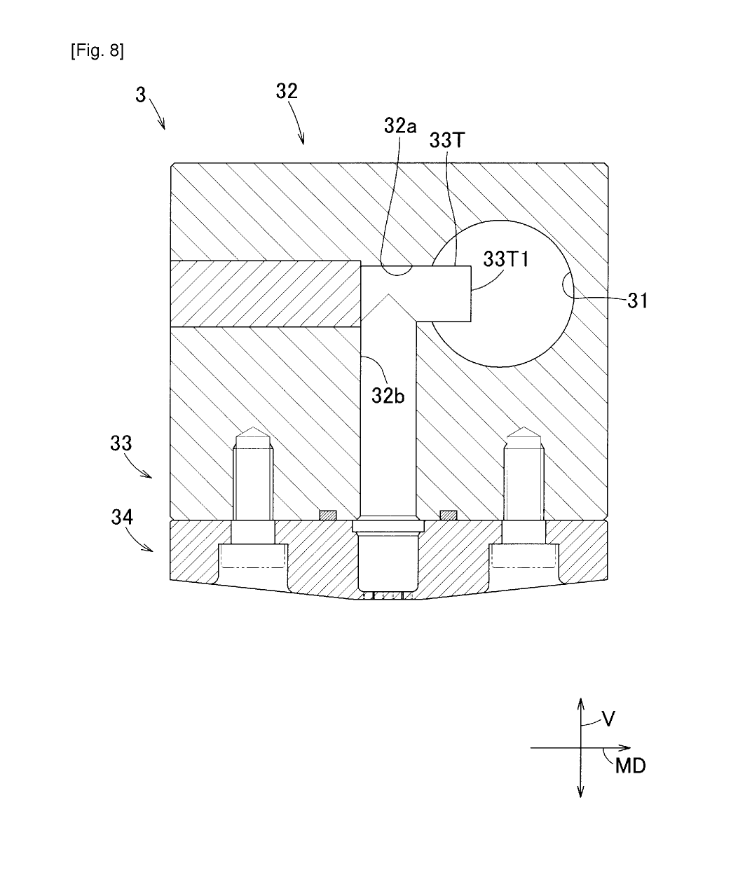

In the embodiment illustrated in FIG. 8, conduit segments 33T are provided in regions in which the distribution channels 32 communicate with the common channel 31, i.e., conduit segments 33T extend through the peripheral surface of the common channel 31 from the outside to project inside the common channel 31. Distal openings 33T1 of the respective conduit segments 33T are where the distribution channels 32 directly communicate with the common channel 31. With the steam injection mechanism 3 constructed in this manner, the conduit segments 33T can prevent water condensed from steam from flowing along the inner peripheral surface of the common channel 31 into the respective distribution channels 32. In this way, invasion of undesirable condensed water can be reliably prevented.

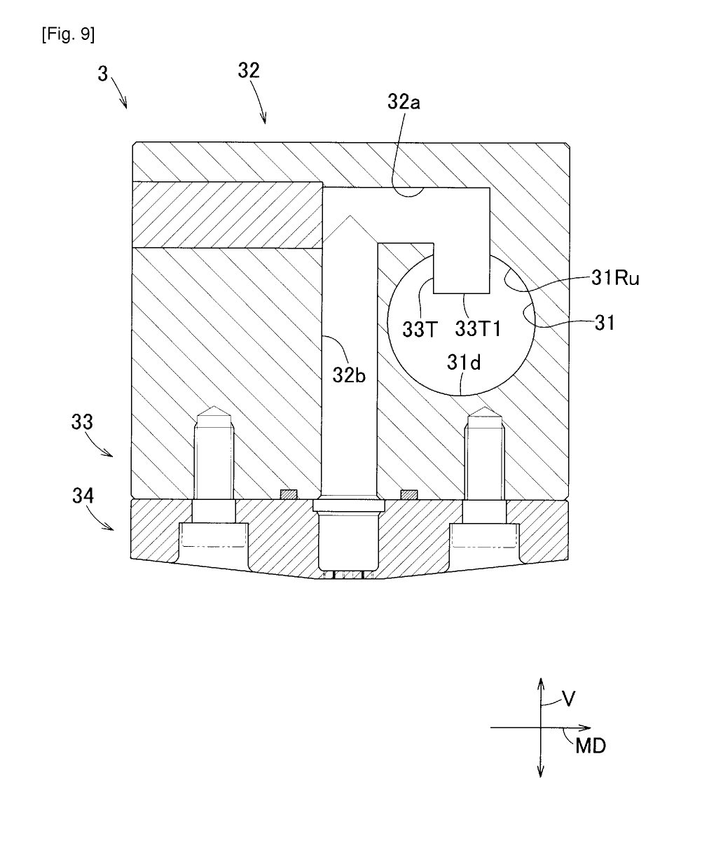

The embodiment illustrated in FIG. 9 similar to the embodiment illustrated in FIG. 8 except that the conduit segments 33T extend downward into the common channel 31 from the outside to project inside the common channel 31 in the vertical direction. In this steam injection mechanism 3, the lowermost region 31d of the common channel 31 functions as the condensed water collecting region. If the steam injection mechanism 3 is located under the conveyor 2, i.e., the positional relationship is turned upside down, an upper peripheral surface 31Ru of the common channel 31 is outside the conduit segments 33T and consequentially is not directly communicating with the first segments 32a of the distribution channels 32 and functions as the condensed water collecting region. In this upside down relationship, distal openings 33T1 of the respective conduit segments 33T are where the distribution channels 32 directly communicate with the common channel 31 and are higher, in the vertical direction V, than the condensed water collecting region 31Ru.

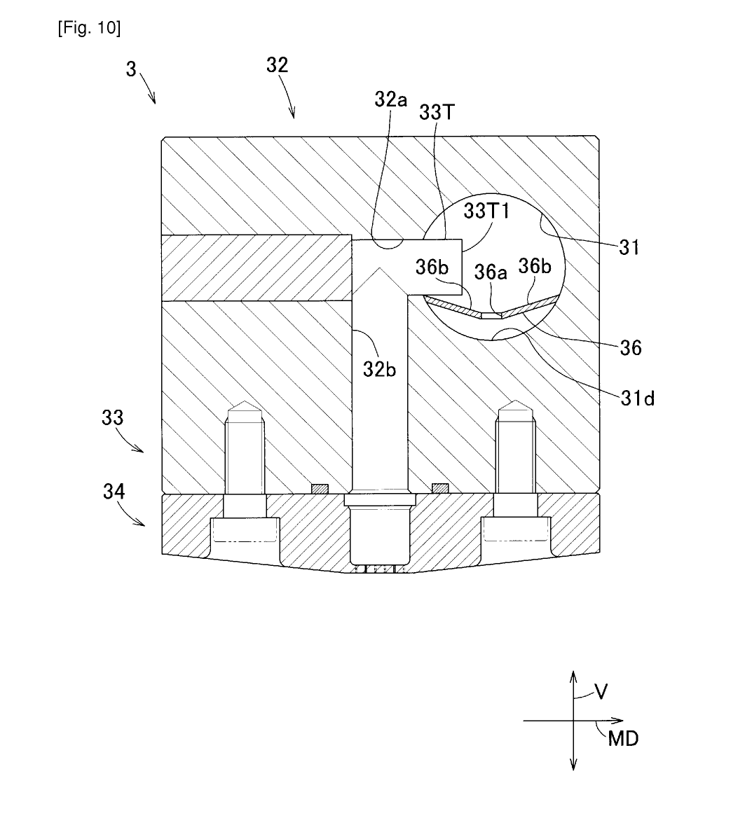

In the embodiment illustrated in FIG. 10, the common channel 31 is provided with a partition 36 dividing the common channel 31 into upper and lower regions as viewed in the cross-section and the distribution channels 32 communicate with the common channel 31 above the partition 36. The partition 36 extends in the cross direction CD and comprises, as viewed in the front-back direction, both lateral segments 36b sloping down from the inner peripheral surface of the common channel 31 toward a central segment. The partition 36 is formed in the central segment as viewed in the front-back direction with cutouts 36a arranged at predetermined intervals in the cross direction CD.

In the steam injection mechanism 3 according to the present embodiment, an amount of condensed water accumulating on the inner peripheral surface of the common channel 31 moves downward along the inner peripheral surface of the common channel 31 under the effect of gravity and further moves along the lateral segments 36b, via cutouts 36a so as to be collected in the lowermost region 31d of the common channel 31. The partition 36 divides the inner space of the common channel 31 into the lower space serving as the condensed water collecting area and the upper space from which the distribution channels 32 are branched. In consequence, steam being in direct contact with condensed water would not flow, or at least unlikely to flow, into the distribution channels 32. In other word, steam at a temperature as low as or close to the saturation temperature would not be injected, or at least unlikely to be injected, to the object 100 to be processed. In some embodiments, cutouts 36a are eliminated if the partition 36 is otherwise water permeable, at least in the direction from the upper region to the lower region.

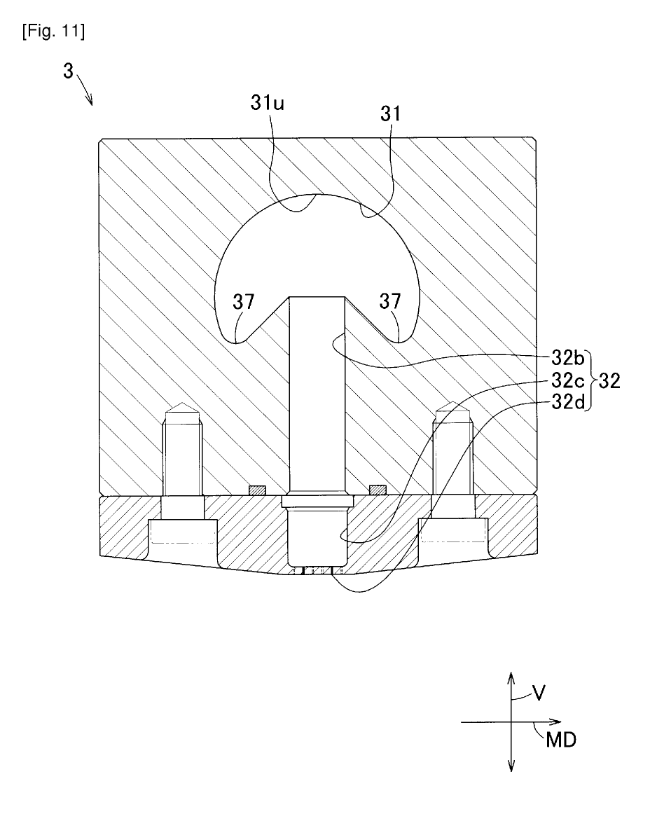

Finally, in the embodiment illustrated in FIG. 11, each of the distribution channels 32 is defined by the second segment 32b, the third segment 32c and the steam injection orifices 32d continuously extending in the vertical direction wherein the distribution channel 32 underlies the common channel 31. The common channel 31 is formed on both sides of the region in which the distribution channel 32 is branched from the common channel 31 with downward depressed portions 37 as viewed in the cross-section. In the case of the steam injection mechanism according to the present embodiment, these depressed portions 37 define the lowermost region which is not directly communicated with the distribution channels 32 and serve as the condensed water collecting areas. If the steam injection mechanism 3 is located under the conveyor 2, i.e., the positional relationship is turned upside down, the uppermost region 31u of the common channel 31 functions as the condensed water collecting region.

The first aspects described above may be arranged in at least the following items:

A product processing apparatus having a steam injection mechanism comprising, and the steam injection mechanism including a common channel through which steam supplied from a steam supply source flows and distribution channels branched from the common channel to distribute the steam from the common channel wherein the steam is injected from steam injection orifices formed in distal ends of the distribution channels to an object to be processed, wherein: the common channel is provided with a region adapted to collect water condensed from steam.

Also, the second aspects described above may be arranged in at least the following items:

(ix) A method of making the steam injection mechanism defined above comprising: (a) boring the rectangular solid-shaped first block in the cross direction from a first side wall to a second side wall as viewed in the cross direction to form the common channel; (b) boring the first block in the front-back direction from any one of side walls in the front-back direction to the common channel; (c) stopping the one side wall through which the bored openings extend in the front-back direction to the first segments; and (d) boring upward the first block from may be bored upward in the vertical direction from a bottom wall to the first segment to form the second segment.

One or more aspect described in the above items (i) and (ix) may provide one or more of the following advantageous effects:

The common channel is provided with the condensed water collecting regions so that the condensed water may be separated from steam. In this way, the steam injection mechanism can restrict accumulation of water on the object to be processed.

Additionally, one or more of the following embodiments are provided in accordance with further aspects:

(ii) The common channel is formed to extend in a horizontal direction; and the distribution channels communicate with the common channel between a horizontal tangential line to the uppermost point of the common channel and a horizontal tangential line to the lowermost point of the common channel as viewed in a cross-section taken orthogonally to a direction in which the common channel extends.

(iii) The distribution channels communicate with the common channel above a lower half of the common channel as viewed in a cross-section.

(iv) A dimension of the common channel in the cross-section as measured in a direction orthogonal to the direction in which the common channel extends and to a vertical direction is gradually reduced downward.

(v) Regions in which the distribution channels communicate with the common channel are formed with conduit sub-segments; and the conduit sub-segments extend into the common channel through a peripheral surface of the common channel from the outside.

(vi) Each of the distribution channels includes only one turn point.

(vii) The common channel is provided with a partition serving to divide the common channel into upper and lower sides as viewed in the cross-section; and the distribution channels communicate with the common channel above the partition.

(viii) A rectangular block-shaped first block including a part of the common channel, the distribution channels, and a vertical direction, a cross direction and a front-back direction being orthogonal one to another; and a second block including a part of the distribution channels and the steam injection orifices; and wherein the first block comprises: the common channel extending in the cross direction from a first side wall to a second side wall as viewed in the cross direction; first segments extending from the common channel in the front-back direction to form respective parts of the distribution channels; and second segments extending downward from associated the first segments to a bottom wall in the vertical direction to form respective parts of the distribution channels.

According to the embodiments in the above (ii) to (viii), the advantageous effect(s) set forth at (a) is/are better ensured. It should be noted that features of these embodiments may be taken in isolation or in combination with one another. Further advantageous effects of the respective embodiments may be obtained as discussed in the respective related descriptions.

The entire disclosure of Japanese Patent Application No. 2010-079670 filed on Mar. 30, 2010 including specification, drawings and abstract is herein incorporated by reference in its entirety.

1. A steam injection mechanism, comprising:
a common channel through which steam supplied from a steam supply source is arranged to flow;
distribution channels branched from said common channel to distribute said steam from said common channel; and
steam injection orifices formed at distal ends of said distribution channels to inject the streams of steam onto an object to be processed,
wherein:
said common channel is provided with a region adapted to collect water condensed from steam regardless of whether the steam injection orifices are oriented upward or downward.

2. The steam injection mechanism defined by claim 1 wherein:
said distribution channels communicate with said common channel between a horizontal tangential line to the uppermost point of said common channel and a horizontal tangential line to the lowermost point of said common channel as viewed in a cross-section taken orthogonally to a direction in which said common channel extends.

3. The steam injection mechanism defined by claim 2 wherein said distribution channels communicate with said common channel above a lower half of said common channel as viewed in said cross-section.

4. The steam injection mechanism defined by claim 2 wherein a dimension of said common channel in said cross-section as measured in a direction orthogonal to the direction in which said common channel extends and orthogonal to a vertical direction is gradually reduced toward the steam injection orifices.

5. The steam injection mechanism defined claim 2 wherein:
regions in which said distribution channels communicate with said common channel are distal openings of conduit segments that extend into said common channel through a peripheral surface of said common channel from the outside.

6. The steam injection mechanism defined by claim 1 wherein each of said distribution channels includes a maximum of only one turn point.

7. The steam injection mechanism defined by claim 2 wherein:
said common channel is provided with a partition serving to divide said common channel into upper and lower sides as viewed in said cross-section; and
said distribution channels communicate with the upper side of said common channel above said partition.

8. The steam injection mechanism defined by claim 2, comprising:
a rectangular block-shaped first block including said common channel, a part of each of said distribution channels, and a vertical direction, a cross direction and a front-back direction being orthogonal one to another; and
a second block including another part of each of said distribution channels and said steam injection orifices;
wherein the part of each of said distribution channels in said first block comprises:
said common channel extending generally in said cross direction from a first side wall to a second side wall of said first block as viewed in said cross direction;
a first segment extending from said common channel in said front-back direction; and
a second segment extending downward from associated said first segment to a bottom wall of the first block in said vertical direction.

9. The steam injection mechanism defined by claim 1, wherein the region adapted to collect water condensed from steam includes depressions which are provided on both sides of a region in which the distribution channels are branched from the common channel, and which are the lowermost region of the common channel.

10. The steam injection mechanism defined by any one of claim 1, wherein the common channel is slanted relative to the horizontal plane.

11. A product processing apparatus, comprising:
a conveyor for transporting an object to be processed in a machine direction; and
a steam injection mechanism extending across the conveyor in a cross direction transverse to the machine direction;
wherein said steam injection mechanism comprises
a common channel through which steam supplied from a steam supply source is arranged to flow;
at least one distribution channel branched from said common channel to distribute said steam from said common channel; and
steam injection orifices formed at a distal end of said distribution channel and oriented toward the conveyor to inject the steam on to the object to be processed,
wherein said common channel is provided with a condensed water collecting region adapted to collect water condensed from steam regardless of whether the steam injection mechanism is positioned below or above the conveyor.

12. The apparatus defined by claim 11, wherein:
said common channel is slanted relative to the horizontal plane to facilitate drainage of the condensed water from the condensed water collecting region.

13. The apparatus defined by claim 12, wherein:
said common channel is slanted downward toward a downstream side in a direction of flow of steam in the common channel.

14. The apparatus defined by claim 11, wherein:
said distribution channel directly communicates with said common channel in regions above the condensed water collecting region.

15. The apparatus defined by claim 14, wherein:
the condensed water collecting region is the lowest region of the common channel and does not directly communicate with the distribution channel.

16. The apparatus defined by claim 11, wherein:
a dimension of said common channel as measured in a direction orthogonal to the direction in which said common channel extends and orthogonal to a vertical direction is gradually reduced toward the steam injection orifices.

17. The apparatus defined by claim 11, wherein:
a region in which said distribution channel directly communicates with said common channel is a distal opening of a conduit segment that extends into said common channel through a peripheral surface of said common channel from the outside.

18. The apparatus defined by claim 11, wherein:
said common channel is provided with a partition serving to divide said common channel into upper and lower sides as viewed in said cross-section;
said distribution channel directly communicates with the upper side of said common channel above said partition; and
the condensed water collecting region is in the lower side of said common channel below said partition.

19. The apparatus defined by claim 11, wherein:
the condensed water collecting region includes depressions which are provided on both sides of a region where the distribution channel is branched from the common channel, and which are the lowermost region of the common channel.

20. A method of making parts of the steam injection mechanism defined by claim 8 comprising:
(a) boring said first block in said cross direction from a first side wall to a second side wall of said first block as viewed in said cross direction to form said common channel;
(b) boring the first block in said front-back direction from any one of side walls of said first block in said front-back direction up to said common channel to form passageways;
(c) plugging said passageways at said one side wall to form said first segments; and
(d) boring said first block upward in the vertical direction from a bottom wall of said first block up to said first segments to form said second segments.
